(19) United States
(12) Patent Application Publication
(10) Pub. No.: US 2003/0162054 A1
(43) Pub. Date: Aug. 28, 2003

(54) Red organic electroluminescent device

(75) Inventors: Liang-Jyi Chen, Taipei (TW); Wen-Kou Weng, Taipei (TW); Chun-Neng Ku, Hsinchu (TW); Po-Yen Lu, Taoyuan (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 10/394,020

(22) Filed: Mar. 24, 2003

Related U.S. Application Data
(63) Continuation-in-part of application No. 09/855,649, filed on May 16, 2001.
Application No. 09/855,649 is a continuation-in-part of application No. 09/810,244, filed on Mar. 19, 2001, now abandoned.

(30) Foreign Application Priority Data
Mar. 23, 2001 (TW) 90106875

(51) Int. Cl. H05B 33/14

(52) U.S. Cl. 428/690; 428/917; 313/504; 252/301.16; 549/398; 549/426

(57) ABSTRACT

The present invention discloses a red organic EL device containing compound which allows EL emission to be shifted to the red spectral region, and a higher purity in color for red EL devices is obtained. The, synthesis of the compound is easy and the product yield is improved compared to the prior art. Moreover, the red organic EL devices fabricated conform with existing NTSC standards.

This application is a continuation-in-part of application Ser. No. 09/855,649 filed on May 16, 2001, now pending.

### BACKGROUND OF THE INVENTION

1. Field of the Invention

The present invention relates to organic electroluminescent (EL) devices, and more particularly to red organic EL devices.

2. Description of the Prior Art

Organic EL devices are known to be highly efficient and are capable of producing a wide range of colors. Useful applications such as flat-panel displays have been contemplated. Representatives of earlier organic EL devices are Gurnee et al U.S. Pat. No. 3,172,862, and Gurnee U.S. Pat. No. 3,173,050. Typical organic emitting materials were formed of a conjugated organic host material and a conjugated organic activating agent having condensed benzene rings. Naphthalene, anthracene, phenanthrene, pyrene, benzopyrene, chrysene, picene, carbazole, fluorene, biphenyl, terphenyls, and 1,4-diphenyl butadiene were offered as examples of organic host materials.

The most recent discoveries in the art of organic EL device construction have resulted in devices having the organic EL medium consisting of extremely thin layers (<1.0 micrometer in combined thickness) separating the anode and cathode. The organic EL medium is herein defined as the organic composition between the anode and cathode electrodes. In a basic two-layer EL device structure, one organic layer is specifically chosen to inject and transport holes and the other organic layer is specifically chosen to inject and transport electrons. The interface between the two layers provides an efficient site for the recombination of the injected hole-electron pair and resultant electroluminescence.

At present, red EL materials are produced by doping. Its light emission is generally produced by energy transfer between the host material and the guest material. Patents such as U.S. Pat. No. 5,935,720 and European Pat. No. 0791849A1 have disclosed such materials. However, the degree of synthetic complexities of the common material used for red EL elements is high, consequently the yield loss is elevated. Hence, it is necessary to provide a material that is easy to synthesize. In addition, the material preferably has a high purity in color and has properties that conform with NTSC standards (maximum wavelength A max and CIE coordinate).

### SUMMARY OF THE INVENTION

The object of the present invention is to provide a novel compound that is a suitable material for red organic EL elements and devices.

Another object of the invention is to provide a material that is easy to synthesize and has a high purity in color for red organic EL elements and devices.

Another object of the invention is to provide an organic EL device that conforms with NTSC standards.

To achieve the above-mentioned object, the novel compound is produced by connecting a benzene ring at the positions 2 and 3 of a withdrawing group 2,5-dimethyl-4-(2,2-dicyano)pyrane, and connecting a conjugated donating group at position 5. By doing so, the EL emission is shifted to the red spectral region. Hence, a novel material that has a higher purity in color for red EL elements and devices is obtained.

### DETAILED DESCRIPTION OF THE INVENTION

The novel compound of the present invention is shown as the following formula:

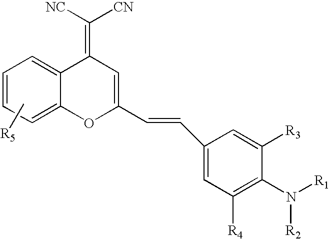

wherein, R₁ and R₂ are individually hydrogen, alkyl of from 2 to 20 carbon atoms, aryl, carbocyclic and other heterocyclic system; R₃ and R₄ are individually hydrogen, alkyl of from 1 to 10 carbon atoms, or R₁ and R₃ (or R₂ and R₄), together with the two carbons of the benzene ring to which R₃ and N are attached, and the nitrogen forming a branched or unbranched 5 or 6 member substituent ring; and R₅ is hydrogen, alkyl of from 1 to 10 atoms and a 5 or 6 member carbocyclic and other heterocyclic system connecting with benzenic ring.

In the above compound, examples of R₁ and R₂ are methyl, ethyl, propyl, n-butyl, aryl, or heteroaryl, including phenyl, furyl, thienyl, pyridyl or other heterocyclic system; R₃ and R₄ are hydrogen, methyl, ethyl, propyl, n-butyl, i-propyl, t-butyl, sec-butyl, t-amyl, wherein R₃ and R₄ are arranged respectively with R₁ and R₂ as follows: R₁, R₃=R₂, R₄=—(CH₂)₂—, —(CH₂)₃—, —(CH₂)₂C(CH₃)₂—; R₅ is hydrogen, methyl, ethyl, propyl, n-butyl, i-propyl, t-butyl, sec-butyl, t-amyl, —(CH₂)₃—,—(CH₂)₄—, or heteroaryl, including phenyl furyl, thienyl, pyridyl and other heterocyclic system connecting with benzenic ring.

R₅ can be one of the groups listed above or R₅ is fused with the benzenic ring.

The synthetic procedure of the above compound is as follows: the mixture of 2-methyl-4-(2,2-dicyanomethylene)chromone, toluene, piperdine, acetic acid and a conjugated donating group is heated and refluxed for 18-20 hours. The mixture is then cooled to room temperature. After filtering, the mixture is washed with a small amount of toluene. Finally, the mixture is purified by sublimation.

Examples of the preferred conjugated donating group are such as 9-formyl-julolidine, 4,(N,N-dimethyl)anlinealdehyde, and 9-formyl-l-(1,1,7,7-tetramethyl)julolidine.

### BRIEF DESCRIPTION OF THE FIGURES

FIG. 1 is the graph illustrating intensity vs wavelength for the EL device prepared in Embodiment 10.

FIG. 2 is the graph illustrating energy vs voltage for the EL device prepared in Embodiment 10.

FIG. 3 is the graph illustrating brightness vs voltage for the EL device prepared in Embodiment 10.

FIG. 4 is the graph illustrating intensity vs wavelength for the EL device prepared in Embodiment 9.

FIG. 5 is the graph illustrating energy vs voltage for the EL device prepared in Embodiment 9.

FIG. 6 is the graph illustrating brightness vs voltage for the EL device prepared in Embodiment 9.

FIG. 7 is the graph illustrating intensity vs wavelength for the EL device prepared in Embodiment 7.

FIG. 8 is the graph illustrating energy vs voltage for the EL device prepared in Embodiment 7.

FIG. 9 is the graph illustrating brightness vs voltage for the EL device prepared in Embodiment 7.

FIG. 10 is the graph illustrating intensity vs wavelength for the EL device prepared in Embodiment 8.

FIG. 11 is the, graph illustrating energy vs voltage for the EL device prepared in Embodiment 8.

FIG. 12 is the graph illustrating brightness vs voltage for the EL device prepared in Embodiment 8.

The following examples exemplify the synthesis of the novel compound and the fabrication of EL devices using the same.

Preferred Embodiments

### EXAMPLE 1

### Synthesis of Compound A

5 g of 2-methyl-4-(2,2-dicyanomethylene)chromone, 20 ml of toluene, 1.5 ml of piperdine, 1.5 ml of acetic acid and 6.5 g of 9-formyl-julolidine were placed in a 50 ml reaction vessel. The mixture was heated and refluxed for 18 hours. The mixture was then cooled to room temperature. After filtering, the mixture was washed with a small amount of toluene to obtain a product yield of 68%. Finally, the mixture was purified by sublimation. The melting temperature of the product is 236 □. ¹H-NMR:8.88(1H, d, J=8.2 Hz), 7.73(1H, t, J=8.6 Hz), 7.43˜7.40(3H, m), 6.77(2H, br), 3.26(4H, t, J=5.8 Hz), 2.75(4H, t, J=4.6 Hz), 1.96(4H, t, J=5.4 Hz)ppm Mass: 393(M+2) IR 2205, 1623, 1588, 1552, 1478, 1312, 1156, 769 cm⁻¹

Formula of compound A is:

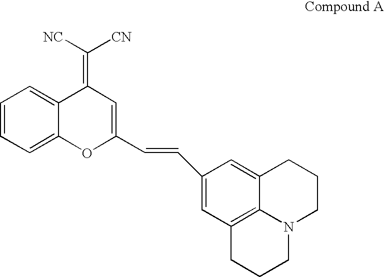

### EXAMPLE 2

### Synthesis of Compound B

5 g of 2-methyl-4-(2,2-dicyanomethylene)chromone, 20 ml of toluene, 1.5 ml of piperdine, 1.5 ml of acetic acid and 5 g of 4-(N,N-dimethyl)anlinealdehyde were placed in a 50 ml reaction vessel. The mixture was heated and refluxed for 18 hours. The mixture was then cooled to room temperature. After filtering, the mixture was washed with a small amount of toluene to obtain a product yield of 78%. Finally, the mixture was purified by sublimation. The melting temperature of the product is 270 □. ¹H-NMR:8.89(1H, d, J=4.8 Hz), 7.72(1H, t, J=7.6 Hz), 7.68˜7.39(6H, m), 7.03(1H, br), 6.67(1H, S), 6.62(1H, d, J=15.6 Hz), 3.08(6H, s) ppm Mass: 393(M⁺) IR2199, 1627, 1591, 1552, 1166, 979, 811 cm⁻¹

Formula of compound B is:

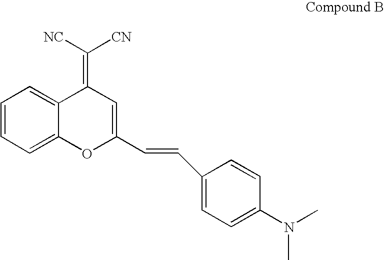

### EXAMPLE 3

### Synthesis of Compound C

5 g of 2-methyl-4-(2,2-dicyanomethylene)chromone, 20 ml of toluene, 1.5 ml of piperdine, 1.5 ml of acetic acid and 7.8 g of 9-formyl-l-(1,1,7,7-tetramethyl)julolidine were placed in a 50 ml reaction vessel. The mixture was heated and refluxed for 18 hours. The mixture was then cooled to room temperature. After filtering, the mixture was washed with a small amount of toluene to obtain a product yield of 68%. Finally, the mixture was purified by sublimation. The melting temperature of the product is 252□. ¹H-NMR:8.88(1H, d, J=8.2 Hz), 7.73(1H, t, J=8.6 Hz), 7.43˜7.40(3H, m), 6.77(2H, br), 3.26(4H, t, J=5.8 Hz), 1.76-1.61(4H,S), 1.25(12H, s) ppm Mass: 449(M+2) IR 2203, 1624, 1585, 1550, 1476, 13120, 1153, 769 cm⁻¹.

Formula of compound C is:

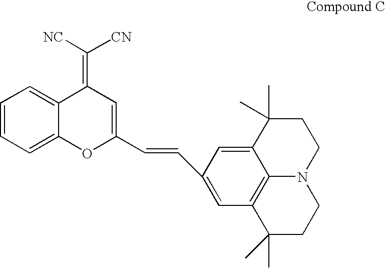

Comparative Embodiment 1: DCM-1(4-(2,2-dicyanomethylene)-2-methyl-6(p-dimethylaminostyrl)-4H-pyrane)

224 mg of 2,5-dimethyl-4-(2,2-dicyanomethylene)-4H-pyrane, 15 ml of toluene, 0.2 ml of acetic acid, 0.2 ml of piperdine and 236 mg of 4-(N,N-dimethyl)anlinealdehyde were placed in a 50 ml reaction vessel. The mixture was heated and refluxed for 20 hours. The mixture was then cooled to room temperature. After filtering, the mixture was washed with a small amount of toluene to obtain a product yield of 74%. Finally, the mixture was purified by sublimation.

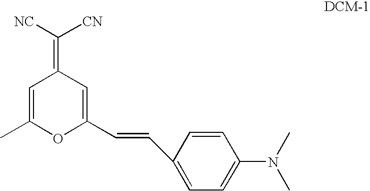

Comparative Embodiment 2: DCM-2(4-(2,2-dicyanomethylene)-2-methyl-6(p-julolidylstyrl)-4H-pyrane)

224 mg of 2,5-dimethyl-4-(2,2-dicyanomethylene)-4H-pyrane, 15 ml of toluene, 0.2 ml of acetic acid, 0.2 ml of piperdine and 315 mg of 9-formyl-julolidine were placed in a 50 ml reaction vessel. The mixture was heated and refluxed for 20 hours. The mixture was then cooled to room temperature. After filtering, the mixture was washed with a small amount of toluene to obtain a product yield of 58%. Finally, the mixture was purified by sublimation.

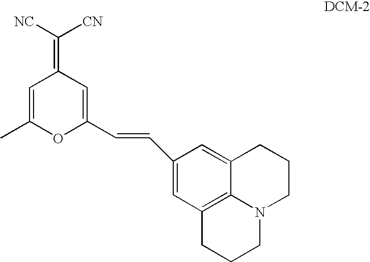

Comparative Embodiment 3: DCJTB(4-(2,2-dicyanomethylene)-2-t-butyl-6(p-(1,1,7,7-tetramethyl)julolidystyrl-4H-pyrane)

224 mg of 2-methyl-5-t-butyl-4-(2,2-dicyanomethylene)-4H-pyrane, 15 ml of toluene, 0.2 ml of acetic acid, 0.2 ml of piperdine and 348 mg of 9-formyl-l-(1,1,7,7-tetramethyl)julolidine were placed in a 50 ml reaction vessel. The mixture was heated and refluxed for 18 hours. The mixture was then cooled to room temperature. After filtering, the mixture was washed with a small amount of toluene to obtain a product yield of 79%. Finally, the mixture was purified by sublimation.

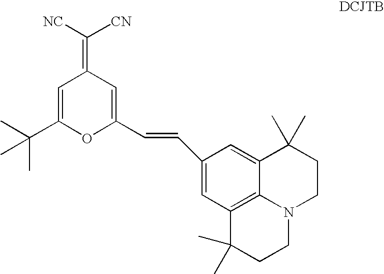

The following embodiments are carried out using the compounds synthesized above to fabricate the organic electroluminescent devices. Each device includes layers of hole-injection layer, hole-transport layer, light emitting layer and electron-transport layer.

Embodiment 4: Fabrication of the EL Device Using Compound A

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 Å). Onto the hole-injection layer, a hole-transporting layer material N,N′-bis-(1-naphthyl)-N,N′-diphenylbenzidine (600 A) was again vapor deposited. Next, onto the hole-transporting layer, the main host alumium-tris-8-hydroxyquinoline and compound A 2% (v/v) (150 Å) as the guest were co-deposited to become the light emitting layer.

Subsequently, alumium-tris-8-hydroxyquinoline (350 Å) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

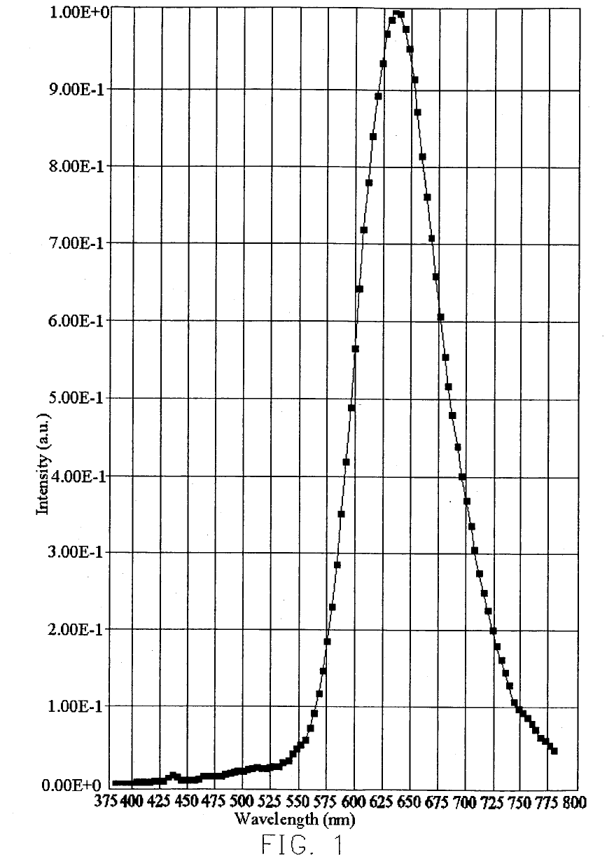

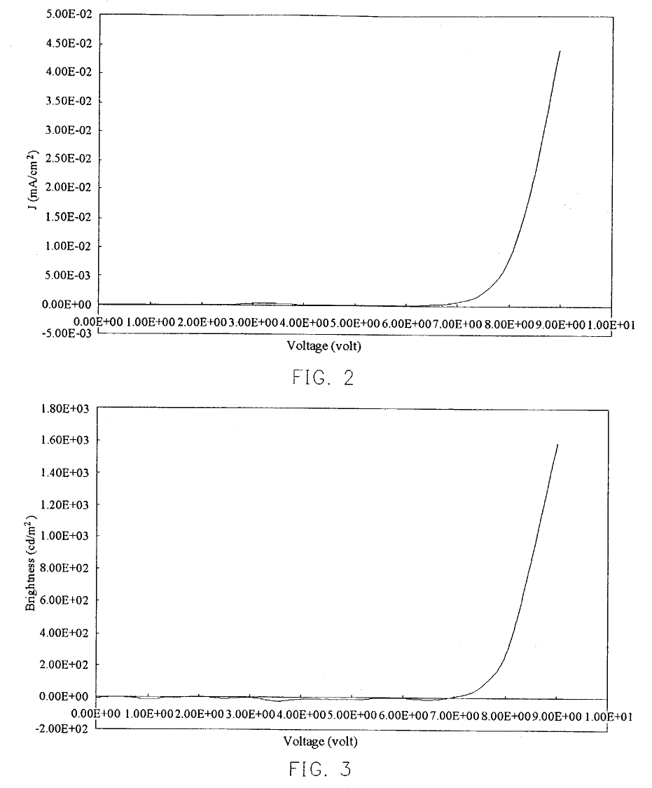

The organic EL device obtained in the above embodiment was then tested for its maximum wavelengthλₘₐₓ in the EL spectra and CIE coordinate. The result is shown in Table 1. It is found that the CIE coordinate and wavelength are very close to NTSC standards: wavelength=650 nm and CIE coordinate x=0.67, y=0.33. The brightness and voltage were then plotted as FIG. 1. FIG. 2 shows the intensity vs wavelength of the obtained EL device.

Embodiment 5: Fabrication of the EL Device Using Compound B

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 Å). On the hole-injection layer, a hole-transporting layer material N,N′-bis-(1-naphthyl)-N,N′-diphenylbenzidine (600 Å) was again vapor deposited. Next, on the hole-transporting layer, the main host alumium-tris-8-hydroxyquinoline and compound B 2% (v/v) (150 Å) as the guest were both vapor deposited to become the light emitting layer.

Subsequently, alumium-tris-8-hydroxyquinoline (350 Å) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

The organic EL device obtained in the above embodiment was then tested for its max wavelength λₘₐₓ in the EL spectra and CIE coordinate. The result is shown in Table 1.

Embodiment 6: Fabrication of the EL Device Using Compound C

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 A). On the hole-injection layer, a hole-transporting layer material N,N′-bis-(1-naphthyl)-N,N′-diphenylbenzidine (600 Å) was again vapor deposited. Next, on the hole-transporting layer, the main host alumium-tris-8-hydroxyquinoline and compound C 2% (v/v) (150 Å) as the guest were both vapor deposited to become the light emitting layer.

Subsequently, alumium-tris-8-hydroxyquinoline (350 A) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

The organic EL device obtained in the above embodiment was then tested for its max wavelength λₘₐₓ in the EL spectra and CIE coordinate. The result is shown in Table 1.

Comparative Embodiment 4: Fabrication of the EL Device Using DCM-1

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 Å). On the hole-injection layer, a hole-transporting layer material N,N′-bis-(1-naphthyl)-N,N′-diphenylbenzidine (600 Å) was again vapor deposited. Next, on the hole-transporting layer, the main host alumium-tris-8-hydroxyquinoline and DCM-11% (v/v) (150 Å) as the guest were both vapor deposited to become the light emitting layer.

Subsequently, alumium-tris-8-hydroxyquinoline (350 Å) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

The organic EL device obtained in the above embodiment was then tested for its max wavelength λₘₐₓ in the EL spectra and CIE coordinate. The result is shown in Table 1.

Comparative Embodiment 5: Fabrication of the EL Device Using DCM-2

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 Å). On the hole-injection layer, a hole-transporting layer material N,N′-bis-(1-naphthyl)-N,N′-diphenylbenzidine (600 Å) was again vapor deposited. Next, on the hole-transporting layer, the main host alumium-tris-8-hydroxyquinoline and DCM-21% (v/v) (150 Å) as the guest were both vapor deposited to become the light emitting layer.

Subsequently, alumium-tris-8-hydroxyquinoline (350 Å) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

The organic EL device obtained in the above embodiment was then tested for its max wavelength λₘₐₓ in the EL spectra and CIE coordinate. The result is shown in Table 1.

Comparative Embodiment 6: Fabrication of the EL Device Using DCJTB

An Indium-tin-oxide coated glass substrate (anode substrate) was sequentially washed in a cleaning solution, rinsed in de-ionized water and dried. Copper phthalocyanine was vapor deposited onto the ITO glass as the hole-injection layer (150 Å). On the hole-injection layer, a hole-transporting layer material N,N′-bis-(1-naphthyl)-N,N′-diphenylbenzidine (600 Å) was again vapor deposited. Next, on the hole-transporting layer, the main host alumium-tris-8-hydroxyquinoline and DCJTB 0.5% (v/v) (150 Å) as the guest were both vapor deposited to become the light emitting layer.

Subsequently, alumium-tris-8-hydroxyquinoline (350 Å) was vapor deposited onto the light emitting layer as the electron-transporting layer. Mg—Ag alloy was then vapor deposited onto the electron-transporting layer as the anode. The element was then packaged in a dry glove box full of nitrogen for protection against ambient environment.

The organic EL device obtained in the above embodiment was then tested for its max wavelength λₘₐₓ in the EL spectra and CIE coordinate. The result is shown in Table 1.

TABLE 1

| | |
|---|---|
| max wavelength | |
| λₘₐₓ (nm) | CIE .x, y. |

the present invention

| | | |
|---|---|---|
| compound A | 670 | 0.66, 0.33 |
| compound B | 630 | 0.66, 0.36 |
| Compound C | 660 | 0.66, 0.34 |

prior art

| | | |
|---|---|---|
| DCM-1 | 610 | 0.62, 0.36 |
| DCM-2 | 640 | 0.64, 0.36 |
| DCJTB | 620 | 0.62, 0.37 |

From Table 1, it is obvious that the material for red organic EL devices provided in the present invention shows improved CIE compared to the material used in the prior art. CIE coordinate and wavelength both conform with NTSC standards (max wavelenth λₘₐₓ: 650 nm; CIE coordinate(for color red) x=0.67, y=0.33). It is also observed that the red color EL of the devices using, the novel compound provided in this invention appears deeper and more saturated. In addition, the material provided by the present invention is easy to synthesize. Consequently, product yield is increased and product costs are lowered.

### Embodiments 7˜10: Fabrication of Organic EL Devices

Same fabrication process as described in Embodiment 6 is followed. Operating conditions are vacuum 2×10⁻⁶ torr and rate of deposition is 1˜2 Å/s. Structure of the EL device is comprised of: ITO (1500 Å)/2-TNATA(50 Å)/NPB (300 Å)/Alq:dopant (R1, or R2, or R3; 1˜2%), 300 Å)/Alq (100 Å)/LiF (5 Å)/Al(1500 Å). Different amount of dopant (%) listed in Table 2 is used.

The following characteristics of the devices are tested and listed in Table 2:

Max wavelength (nm): the peak emission wavelength of the organic EL device

Brightness (max, cd/m²): Maximum brightness (light output) measured when it was driven by a voltage of 9V

Efficiency: the maximum efficiency of the organic EL device

CIE coordinate: the coordinate of color saturation in chromatology, e.g. CIE color coordinates for red is 0.67, 0.33.

TABLE 2

| | | | max | Brightness | Effi- | |
|---|---|---|---|---|---|---|
| | | Dopant | wavelength | (max, | ciency | C.I.E. |
| No. | Dopant | (%) | λₘₐₓ (nm) | cd/m²) | (max) | (x, y) |
| 7 | R1 | 2 | 656 | 1100 | 2.8 | 0.65, 0.33 |
| 8 | R2 | 2 | 648 | 1690 | 2.3 | 0.65, 0.34 |
| 9 | R3 | 1 | 620 | 2250 | 1.4 | 0.61, 0.38 |
| 10 | R3 | 2 | 636 | 1620 | 2.1 | 0.63, 0.35 |

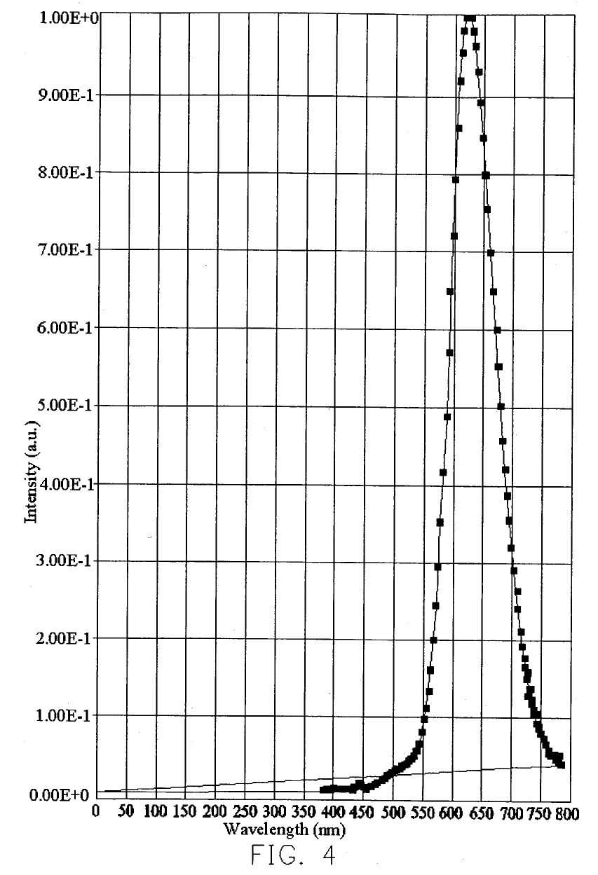

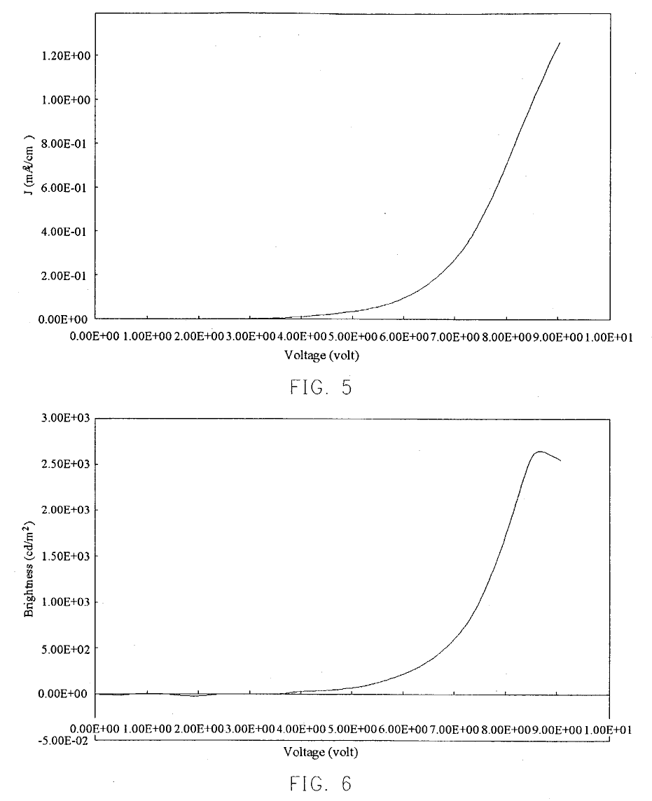

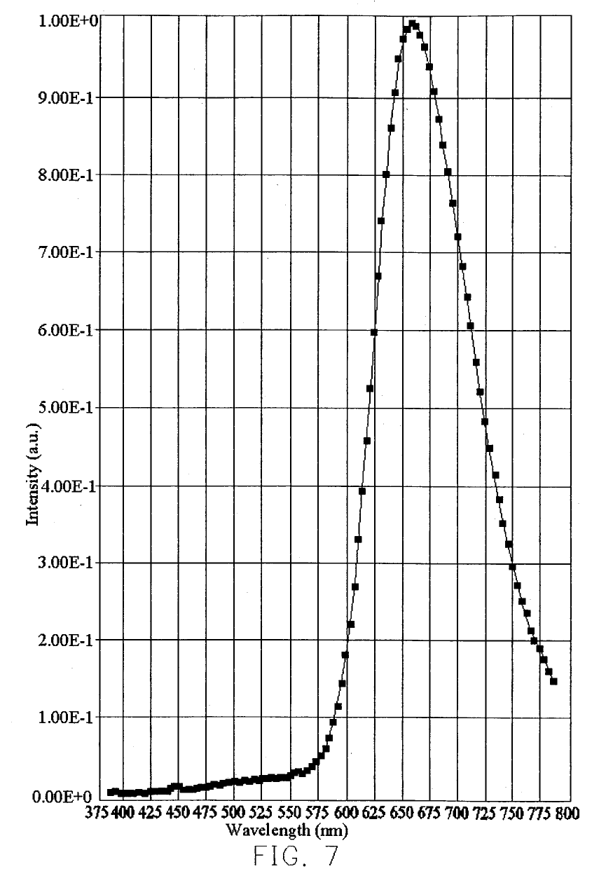

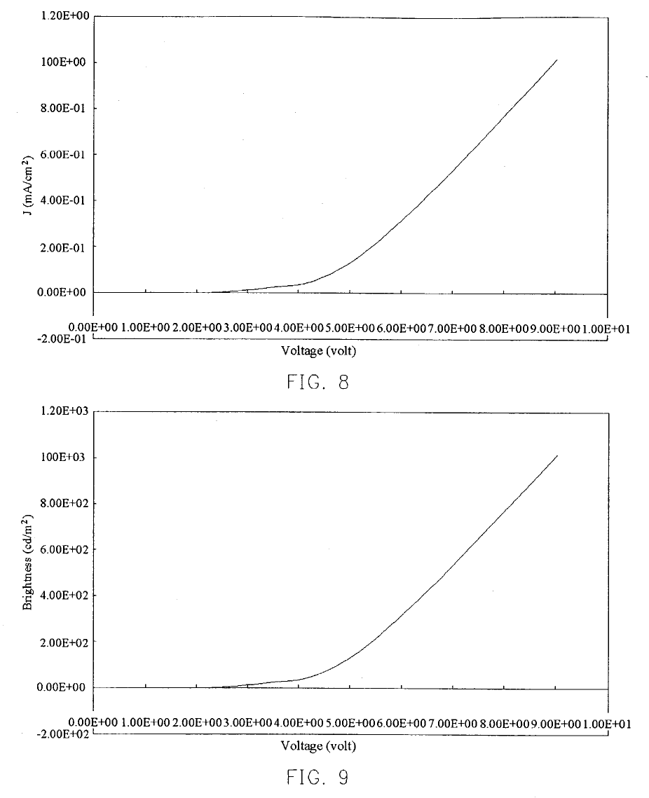

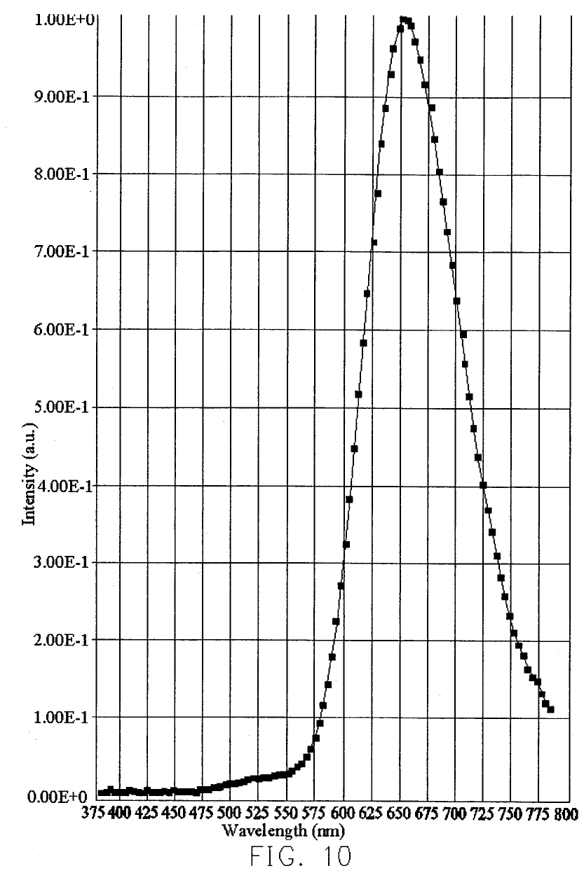

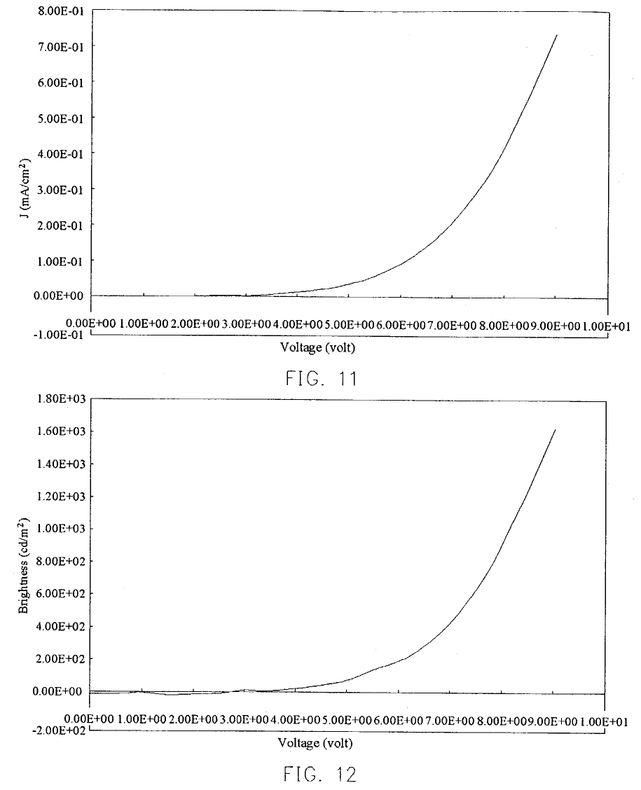

FIGS. 1, 4, 7 and 10 are the graphs illustrating intensity vs wavelength for the EL device prepared in Embodiments 10, 9, 7 and 8 respectively. FIGS. 2, 5, 8 and 11 are the graphs illustrating energy vs voltage for the EL device prepared in Embodiment 10, 9, 7 and 8 respectively. FIGS. 3, 6, 9, and 12 are the graphs illustrating brightness vs voltage for the EL device prepared in Embodiment 10, 9, 7 and 8 respectively.

From Table 2, it is obvious that the red organic EL devices provided in the Embodiments 7-10 exhibit characteristics, such as wavelength and CIE coordinate both conform with NTSC standards (max wavelenth λₘₐₓ: 650 nm; CIE coordinate(for color red) x=0.67, y=0.33). It is also observed that the red color EL of the devices using the novel compound provided in this invention appears deeper and more saturated.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An organic electroluminescent device, comprising an anode, a cathode, and at leas one electroluminescent medium containing a compound of the formula: 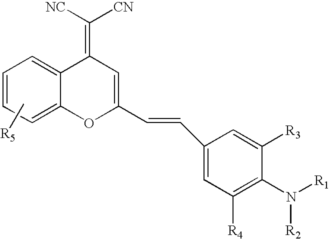
wherein, R₁ and R₂ are individually hydrogen, alkyl of from 2 to 20 carbon atoms, aryl, carbocyclic and other heterocyclic system; R₃ and R₄ are individually hydrogen, alkyl of from 1 to 10 carbon atoms, or R₁ and R₃ (or R₂ and R₄), together with the two carbons of the benzenic ring to which R₃ and N are attached, and the nitrogen forming a branched or unbranched 5 or 6 member substituent ring; and R₅ is hydrogen, alkyl of from 1 to 10 atoms and a 5 or 6 member carbocyclic and other heterocyclic system connecting with benzenic ring.

2. The device as claimed in claim 1, wherein R₁ and R₂ are methyl, ethyl, propyl, n-butyl, aryl, or heteroaryl, including phenyl, furyl, thienyl, pyridyl or other heterocyclic system; R₃ and R₄ are hydrogen, methyl, ethyl, propyl, n-butyl, i-propyl, t-butyl, sec-butyl, t-amyl, wherein R₃ and R₄ are arranged respectively with R₁ and R₂ as follows: R₁, R₃=R₂, R₄=—(CH₂)₂—, —(CH₂)₃—, —(CH₂)₂C(CH₃)2—; R₅ is hydrogen, methyl, ethyl, propyl, n-butyl, i-propyl, t-butyl, sec-butyl, t-amyl, —(CH₂)₃—,—(CH₂)₄—, or heteroaryl, including phenyl furyl, thienyl, pyridyl and other heterocyclic system connecting with benzenic ring.
